(19) United States
(12) Patent Application Publication
(10) Pub. No.: US 2014/0191101 A1
(43) Pub. Date: Jul. 10, 2014

(54) RECUMBENT TRIKE LIFT AND STORAGE MECHANISM

(71) Applicant: Blane Alan Krause, Lee's Summit, MO (US)

(72) Inventor: Blane Alan Krause, Lee's Summit, MO (US)

(21) Appl. No.: 14/148,481

(22) Filed: Jan. 6, 2014

Related U.S. Application Data
(60) Provisional application No. 61/848,593, filed on Jan. 7, 2013.

(51) Int. Cl. F16M 13/00

(52) U.S. Cl. CPC F16M 13/00
USPC 248/331

(57) ABSTRACT

A lifting and storage mechanism for storing a recumbent trike in a garage using the energy of a counterweight or motor is disclosed. The lifting and storage mechanism includes a pulley system that securely holds the trike in a horizontal balanced position while lifting and lowering the trike and while in a stored position. Counterweight reduces the pulling force required to manually lift the trike with pulley system; A motor can be used in place of counterweight to eliminate manual intervention.

### CROSS-REFERENCE TO RELATED APPLICATIONS

This application claims priority to U.S. Provisional Patent Application Ser. No. 61/848,593 filed on Jan. 7, 2013

### STATEMENT REGARDING FEDERALLY SPONSORED RESEARCH OR DEVELOPMENT

Not applicable.

### TECHNICAL FIELD

The present invention relates generally to a system for storing a recumbent trike. More specifically, the present invention discloses a system which balances a recumbent trike and utilizes a counterweight or motorized system to provide mechanical energy to assist with lifting the recumbent trike to a storage position, secure the trike in the storage position, and lower the trike from the storage position.

### BACKGROUND

Typical garages and other storage facilities often are used to store automobiles, boats, patio furniture, holiday decorations, children's toys, bicycles, and other outdoor recreational equipment in order to protect these items from inclement weather or risk of theft. As such, homeowners and other users of garages desire to maximize the available storage space in their garage.

An item that is becoming more common and is difficult to store in a garage is the recumbent trike. Having three wheels, it occupies a large amount of space and is even more difficult to store than a bicycle. During the biking season, recumbent trikes are typically stored on the garage floor for easy and quick access. However, this way of storage can occupy a lot of space and in non-biking seasons, it is necessary to find an alternate storing method or location.

A device commonly used to store bicycles when not in use is a hook-type device or rack that is mounted in the ceiling or on a wall of the garage. Using such a fixed device for a recumbent trike requires the trike owner to balance and manually lift the trike overhead and place the trike on the hooks or rack. This manual storage process is inconvenient, time consuming, and dangerous. Even further, recumbent trikes are most popular with older people who are less capable of lifting a trike.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention are directed to a lifting and storage mechanism utilizing a pulley system coupled to a counterweight that is capable of regulating movement of a lifting arm assembly for storing a recumbent trike or other objects in an elevated position. The counterweight is always in conjunction with a pulley system and lifting arm assembly and is sized to approximately half the weight of the trike in order to assist with lifting the recumbent trike.

A lifting arm assembly and a weighted hook are secured to the pulley system and provide a means of balancing and lifting a long object into a storage position. The lifting arm assembly comprises a bar-like support member having one or more hooks extending outward from the support member and an eye bolt located proximate the mid-span of the support member. The lifting arm assembly and weighted hook are coupled to the pulley system such that the support member and hooks can be raised into a storage position or lowered towards a garage floor by the pulley system.

### BRIEF DESCRIPTION OF THE SEVERAL VIEWS OF THE DRAWINGS

In the accompanying drawings, which form a part of the specification and are to be read in conjunction therewith and in which like reference numerals are employed to indicate like parts in the various views:

FIG. 1 is a perspective view of a lifting and storage mechanism capable of storing a recumbent trike in accordance with an embodiment of the present invention;

FIG. 2 is an elevation view of a portion of the lifting and storage mechanism in accordance with an embodiment of the present invention;

FIG. 3 is a perspective view of a lifting arm assembly and weighted hook in accordance with an embodiment of the present invention;

FIG. 4 is a detailed perspective view of a portion of the pulley system in accordance with an embodiment of the present invention;

FIG. 5 is a detailed perspective view of a portion of the pulley system in accordance with an embodiment of the present invention;

FIG. 6 is a perspective view of a lifting and storage mechanism capable of storing two bicycles in accordance with an embodiment of the present invention;

FIG. 7 is a perspective view of a lifting and storage mechanism capable of storing a canoe or kayak in accordance with an embodiment of the present invention;

### DETAILED DESCRIPTION

With reference to the drawings, wherein like reference characters designate like parts throughout the different views, a lifting and storage mechanism is disclosed. More specifically, a system for storing a recumbent trike in a garage is disclosed, where the system harnesses energy from a counterweight or a motor into a confined spaced adjacent to the ceiling. Through this system, a recumbent trike is stored such that the storage space of a garage can be more efficiently utilized while also reducing the risk of injury when trying to manually store a recumbent trike in an elevated position, such as on a garage wall.

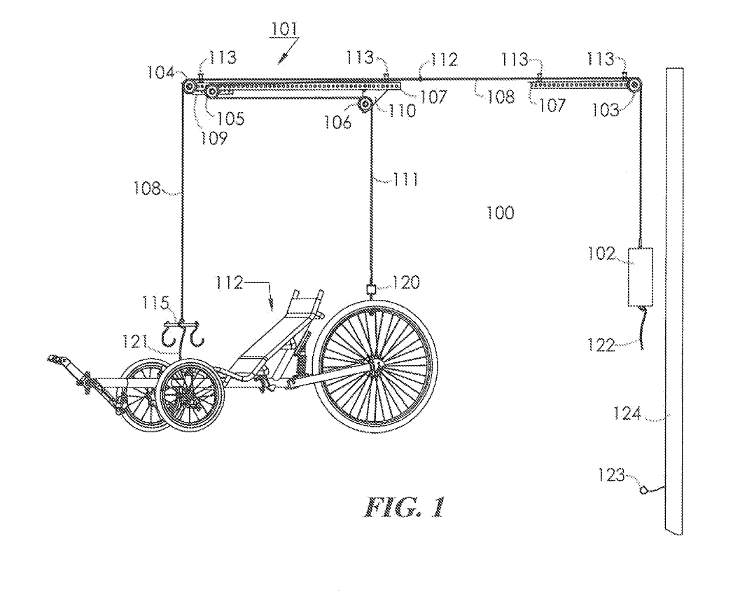

Referring initially to FIG. 1, a lifting and storage mechanism 100 in accordance with an embodiment of the present invention is depicted. The lifting and storage mechanism 100 comprises a pulley system 101 coupled to a counterweight 102. The pulley system 101 has a plurality of pulley wheels 103, 104, 105, 106 and one primary cable 108 running through the plurality of pulley wheels 103, 104. The pulley wheels 103, 104, 105, 106 are preferably three inch diameter wheels and are bolted in-line on one side of the slotted angle bracket 107.

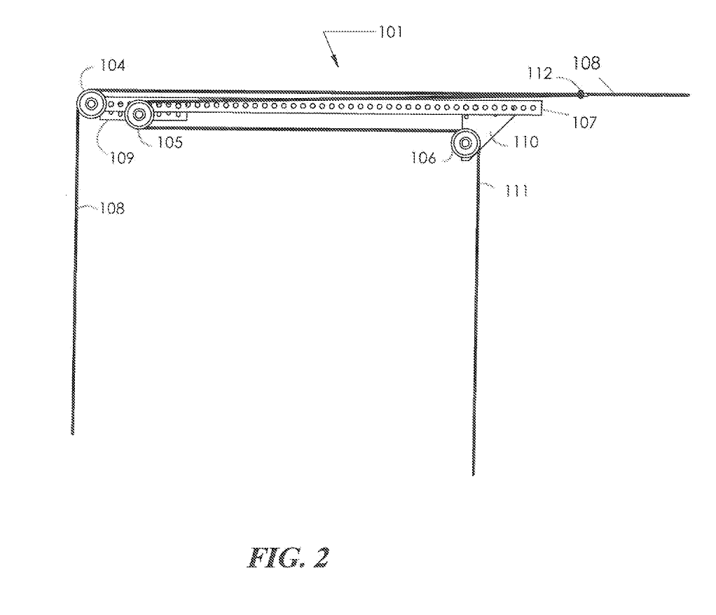

Referring to FIG. 2, an embodiment of the present invention is shown having a secondary cable 111 clamped with cable clamp 112 to primary cable 108. Pulley 105 is bolted slightly lower than pulley 104 on slotted cleat 109 and within a few inches from pulley 104. At opposite end of slotted angle bracket 107, pulley 106 is bolted to gusset plate 110 at a point slightly lower than pulley 105. By routing secondary cable 111 around pulley 105 and back over pulley 106, the primary cable 108 and secondary cable 111 can be separated an appropriate distance for lifting opposite ends of recumbent trike 112. The union of primary cable 108 with secondary cable 111 provides the capability of lifting an object from two independent pulleys 104, 106 while applying a pulling force from only one cable 108.

The pulley system 101 is positioned within the garage and in conjunction with the counterweight 102 by a series of angle steel brackets 107, as shown in FIG. 1. That is, the slotted angle bracket 107 is suspended from the wood structure of the garage ceiling with lag bolts and spacers 113 providing clearance for pulleys to spin freely. As shown in FIG. 1, the slotted angle bracket 107 can be mounted at any desired point on the ceiling at which the recumbent trike is to be stored. The pulley 103 can be mounted close to a perimeter wall so that movement of counterweight 102 is unobstructed and away from open area of garage floor. Rope handle 122 can be used to retract and pull counterweight 102 to and from the ceiling.

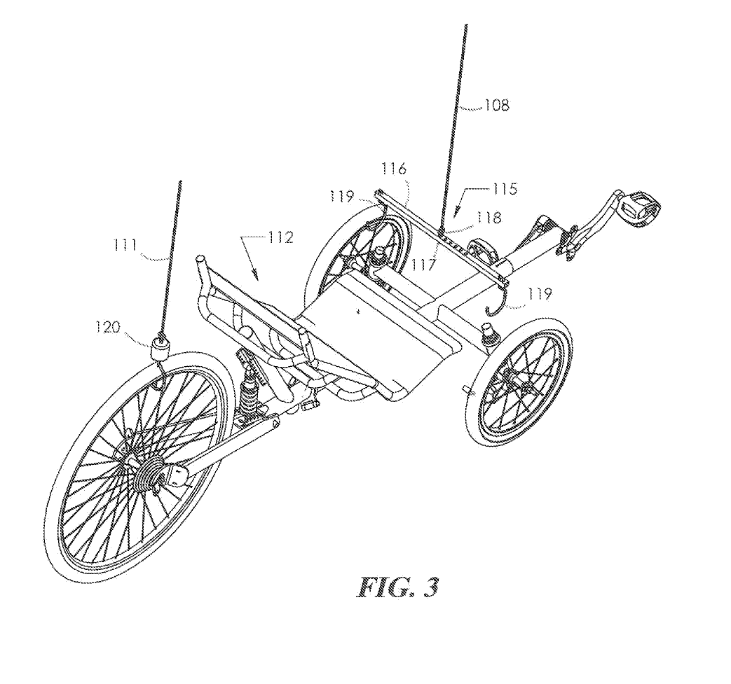

Referring to FIG. 3, the pulley system 101 also includes a lifting arm assembly 115. The lifting arm assembly 115 comprises a bar-like support member 116 having opposing ends and a center opening 117 for an eye bolt 118. The support member 116 is a generally square cross sectional bar but could be made from other shaped or solid bar stock. The cable 108 extends from pulley 104 and is secured to eye bolt 118. Extending beneath and generally perpendicular to each end of the support member 116 is a J-shaped hook 119. The hooks 119 can be used to mount the axle of the recumbent trike 112. In an upright configuration, the two J-shaped hooks 119 are placed at opposing ends of the axle as shown in FIG. 3. Rope handle 121, shown in FIG. 1, can be used to retract and pull lift arm assembly 115 to and from ceiling when trike 112 is not on the lift.

The pulley system also includes a weighted hook 120 that is secured to cable 111 and suspends from pulley 106. The weighted hook 120 can be used to lift the fixed wheel of recumbent trike 112.

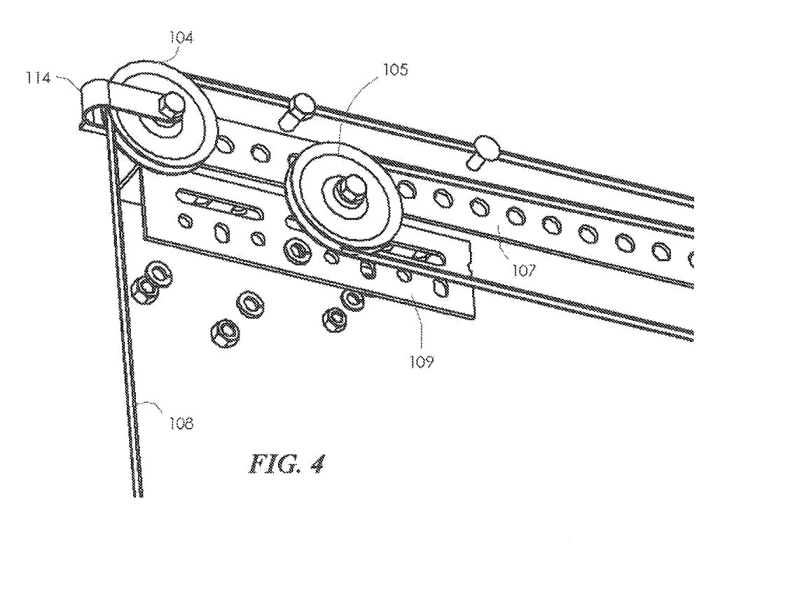

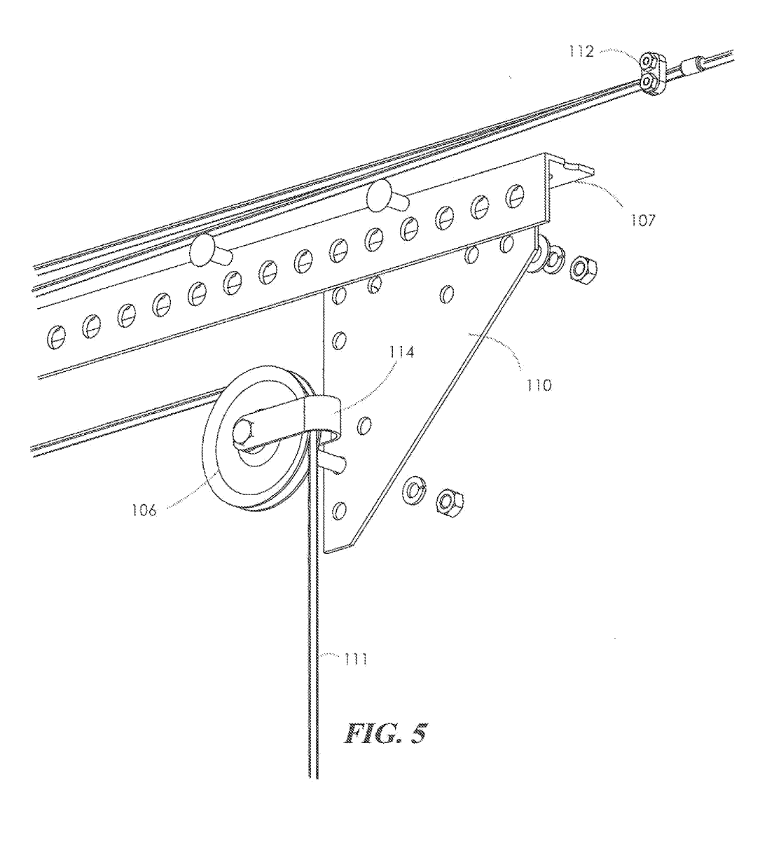

FIG. 4 shows a perspective view of one section of pulley assembly 101 with slotted cleat 109 being assembled. Safety strap 114 is part of pulley assembly 101 and prevents moving cable 108 from dropping toward floor in the event that cable 108 becomes disengaged from pulley 104. Safety strap 114 is also installed at opposite end of pulley assembly 101 as shown in FIG. 5 and prevents cable 111 from dropping in the event that it becomes disengaged from pulley 106.

In operation, a user secures the two wheel axle of a recumbent trike 112 to the J-shaped hooks 119 of the lifting arm bracket assembly 115. The weighted hook 120 is placed under the fixed wheel of trike 112 as shown in FIG. 1 or under a secure location of the rear cargo rack. The counterweight holds the J-shaped hooks 119 firmly in place. The user then pulls rope handle 122 to lift the trike 112 up toward the ceiling as the cable 108 is retracted and the pulley system 101 is activated. The counterweight 102 is approximately half the weight of the trike 112 and therefore, reduces the required pulling force by a factor of 2. As the trike 112 is suspended from the lift, the trike 112 is securely balanced from front to back and from side to side. Once the trike 112 is fully lifted to ceiling, counterweight 102 is securely hooked to a cable leader 123 mounted to garage wall 124.

To lower the recumbent trike 112 from the stored position, the user unhooks counterweight 102 and allows weight of trike 112 to lower itself while firmly holding rope handle 122. After removing trike 112 from weighted hook 120 and lift arm 115, user lowers counterweight by firmly holding rope handle 121.

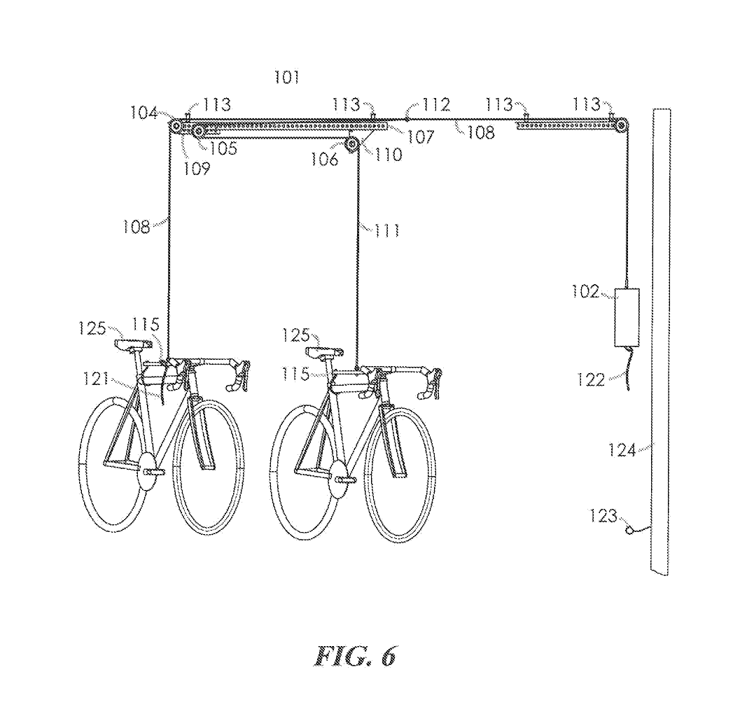

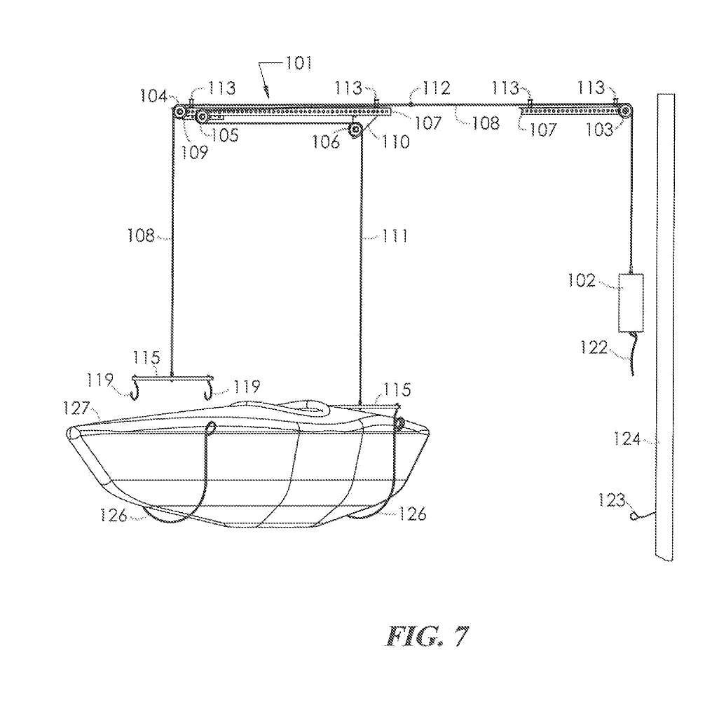

By replacing weighted hook 120 with a second lift arm assembly 115, the lifting and storage mechanism can also be used to lift and store two bicycles 125 as shown in FIG. 6, or a kayak or canoe 127 as shown in FIG. 7. To store a long object such as a canoe 127, the length of slotted angle bracket 107 in pulley assembly 101 is increased and sized to accommodate the length of the canoe 127. Straps or rope 126 can be used to suspend the ends of canoe 127 from the lift arm assemblies 115. The size of counterweight 102 can also be increased to accommodate the increased weight of two bicycles 125 or a canoe 127.

The present invention has been described in relation to particular embodiments, which are intended in all respects to be illustrative rather than restrictive. Alternative embodiments will become apparent to those of ordinary skill in the art to which the present invention pertains without departing from its scope. Substitutions may be made and equivalents employed herein without departing from the scope of the invention as recited in the claims. It will be understood that certain features and subcombinations are of utility and may be employed without reference to other features and subcombinations. This is contemplated and within the scope of the claims.

The invention claimed is:

1. A lifting and storage mechanism comprising:
a pulley system coupled to a counterweight and having a plurality of pulley wheels, at least two cables, and a cable clamp;
a lifting arm assembly secured to the pulley system and having at least one J-shaped hook; and,
a weighted J-shaped hook;
wherein the force of the counterweight in a vertical direction controls movement of the pulley system, and thereby regulates vertical height of the lifting arm assembly in conjunction with the weighted J-shaped hook.

2. The mechanism of claim 1, wherein two J-shaped hooks and the weighted J-shaped hook support a recumbent trike in the elevated storage region.

3. The mechanism of claim 1, wherein two lift arm assemblies support two bicycles in the elevated storage region.

4. The mechanism of claim 1, wherein two lift arm assemblies support a canoe in the elevated storage region.

5. The mechanism of claim 1, further comprising angle brackets secured adjacent a ceiling of a garage for providing one or more elevated storage regions.

6. The mechanism of claim 1, wherein a motor system replaces the counterweight.

7. The mechanism of claim 6, wherein the pulley system lowers the one or more J-shaped hooks from the elevated storage position upon actuation of the motor.

8. The mechanism of claim 6, wherein the pulley system raises the one or more J-shaped hooks into the elevated storage position upon actuation of the motor.

9. A lifting arm assembly for securing a load, the assembly comprising:
a bar-like support member having opposing ends;
one or more J-shaped hooks secured to the support member and extending generally perpendicular from the support member; and,
an eye bolt secured at approximately a mid-span of the support member and extending away from the support member, opposite of the J-shaped hooks;
wherein a cable of a pulley system is coupled to the eye bolt so as to control the raising and lowering of the support member and the one or more J-shaped hooks hold an item for storage.

10. The lifting arm assembly of claim 9, wherein the one or more J-shaped hooks comprises two J-shaped hooks spaced at opposing ends of the support member.
